(19) United States
(12) Patent Application Publication
(10) Pub. No.: US 2019/0085881 A1
(43) Pub. Date: Mar. 21, 2019

(54) MOBILE DEVICE MOUNTING SYSTEM AND HOLDER

(71) Applicant: iOttie, Inc., New York, NY (US)

(72) Inventors: Phisitsuk Paul SUKPHISIT, Englewood, NJ (US); Jeremy LEEDS-FRANK, Glen Cove, NY (US); Jeremy Michael CONNELL, Brooklyn, NY (US)

(73) Assignee: iOttie, Inc., New York, NY (US)

(21) Appl. No.: 15/709,412

(22) Filed: Sep. 19, 2017

(51) Int. Cl. F16B 2/04; A45F 5/00; F16M 13/02

(52) U.S. Cl. CPC F16B 2/04; H04B 1/3877; F16M 13/02; A45F 5/00

(57) ABSTRACT

A mounting system configured to engage with a support member and a bracket adapter for a mobile device. The mounting system primarily comprises a base which engages with a support member, and a rectangular upper section which engages with a mobile device. The mounting system has a locking mechanism, which prevents the mobile device from being removed when the locking mechanism is engaged.

### FIELD OF THE INVENTION

The invention is directed to a mounting system, and more particularly, to a mounting system for use with a portable device.

### BACKGROUND OF THE INVENTION

Mobile devices, such as mobile phones, navigation systems, and multimedia players are ubiquitous in daily life. Users and developers are continuously finding new uses for mobile devices, and as a result, users are also finding cause to utilize their mobile devices in situations not previously thought of, for instance, while riding a bicycle, motorcycle, moped, or e-bike. A few of the most commonly used mobile devices, by riders of bicycles, motorcycles, mopeds, or e-bikes, are mobile phones, music players, or GPS navigation systems.

Using a mobile device while riding a bicycle, motorcycle, moped, or e-bike generally requires that the rider dedicate one or both hands to the mobile device, which can be dangerous for the rider. Moreover, having the mobile device unsecured while riding presents the risk of accidentally dropping and damaging the device, resulting in a need for a device holder which is versatile and flexible for carrying, installation, and removal.

Commonly known methods for mounting mobile devices generally require overly complicated systems with many steps. Therefore, there is still a need for a mounting system that installs quickly and easily while also firmly securing the mobile device.

### SUMMARY OF THE INVENTION

An embodiment of the invention is directed to a mounting system for a mobile device.

The mounting system of one embodiment of the invention comprises:

a base;

complimentary rectangular upper bodies;

a locking mechanism; and

a bracket adapter having a recess capable of receiving the upper bodies;

wherein

the complimentary rectangular upper bodies form a square interface when in a combined state;

wherein the bracket adapter is capable of being affixed to a mobile device; and

the locking mechanism, when engaged, prevents the upper bodies from combining to form a square.

### BRIEF DESCRIPTION OF DRAWINGS

FIG. 1 is a perspective view of a mounting system and support member according to an embodiment of the invention;

FIG. 2 is a perspective view of a mounting system and bracket adapter according to an embodiment of the invention;

FIG. 3 is a side perspective view of a mounting system and bracket adapter according to an embodiment of the invention;

FIG. 4 is bottom perspective view of a mounting system according to an embodiment of the invention, in a locked position;

FIG. 5 is an exploded view of a mounting system according to an embodiment of the invention;

FIG. 6 is perspective view of a mounting system according to an embodiment of the invention, in a locked position;

FIG. 7 is a perspective view of a mounting system according to an embodiment of the invention, in an unlocked position;

FIG. 8 is top view of a mounting system according to an embodiment of the invention, in a locked position;

FIG. 9 is a top view of a mounting system according to an embodiment of the invention, in an unlocked position;

FIG. 10 is front view of a mounting system according to an embodiment of the invention, in a locked position;

FIG. 11 is a front view of a mounting system according to an embodiment of the invention, in an unlocked position;

FIG. 12 is a side view of a mounting system according to an embodiment of the invention, in a closed position;

FIG. 13 is an alternate side view of a mounting system according to an embodiment of the invention, in a closed position;

FIG. 14 is a front view of a bracket adapter according to an embodiment of the invention;

FIG. 15 is a back view of a bracket adapter according to an embodiment of the invention;

FIG. 16 is a side view of a bracket adapter according to an embodiment of the invention;

FIG. 17 is a perspective view of a bracket adapter according to an embodiment of the invention;

FIG. 18 is a top view of a bracket adapter according to an embodiment of the invention;

FIG. 19 is a bottom view of a bracket adapter according to an embodiment of the invention;

FIG. 20 is a side view of a bracket adapter according to an embodiment of the invention;

FIG. 21 is a perspective view of a bracket adapter according to an embodiment of the invention;

FIG. 22 is a top view of a fastener according to an embodiment of the invention; and

FIG. 23 is a perspective view of a fastener according to an embodiment of the invention.

### DETAILED DESCRIPTIONS OF PREFERRED EMBODIMENTS

An embodiment of the invention is directed to a mounting system 100 for a mobile device.

The mounting system 100 of one embodiment of the invention comprises:

a base 110 having a bottom 111 configured to rest on a support member 200;

a first upper body 120 having a substantially rectangular top face 121;

a second upper body 130 having a substantially rectangular top face 131; and

a spring-loaded sliding mechanism 133 configured to slide the second upper body 130 along an axis parallel to a longitudinal axis 210 of the support member 200;

wherein the first upper body 120 is fixedly attached to the base 110 and the second upper body 130 is moveably attached to the base 110.

In one embodiment of the invention the support member 200 may be an element of a handlebar assembly of a bicycle.

In another embodiment, the support member 200 may be a crossbar of scaffolding at a construction site.

In another embodiment, the support member 200 may be the wrist or arm of a user.

The mounting system 100 of one embodiment of the invention further comprises a fastener 400 to install the mounting system 100 on a support member 200. The fastener 400 may be elastic or non-elastic.

In an embodiment of the invention, the base 110 comprises a plurality of protrusions 112. The protrusions 112 may protrude in a direction perpendicular to both a longitudinal axis 210 of a support member 210 and an axis orthogonal to a longitudinal axis 210 of a support member 200.

According to another embodiment of the invention, the fastener 400 comprises a plurality of openings 410, which engage with the plurality of protrusions 112 of the base.

The base 110 of the mounting system 100 rests on the supporting member 200 in such a way that the sliding mechanism 133 of the second upper body 130 is free to move parallel to a longitudinal axis 210 of the supporting member 200.

In an embodiment of the invention, a sliding mechanism 133 moves parallel to a longitudinal axis 210 of a support member 200. By restricting the direction of force applied to the mounting system 100 parallel to a longitudinal axis 210 of a support member 200, the embodiment lessens forces in directions orthogonal to the longitudinal axis 210. Forces in directions orthogonal to the longitudinal axis 210 may cause the mounting mechanism 100 to rotate about the longitudinal axis 210 of the support member 200 such that the mounting mechanism 100 is no longer oriented in a preferred position.

In another embodiment of the invention, when the sliding mechanism 133 is in an open state, the first tapered lip 122 of the first upper body 120 and the tapered lip 132 of the second upper body 130 are separated by a distance greater than or equal to a length of a first dimension of an inner surface 311 of a recess 310 of a bracket adapter 300.

In another embodiment of the invention, when the sliding mechanism 133 is in an open state, the first tapered lip 122 of the first upper body 120 and the tapered lip 132 of the second upper body 130 are separated by a distance greater than or equal to a length of a second dimension of an inner surface 311 of a recess 310 of a bracket adapter 300.

In another embodiment of the invention, the length of a first dimension of an inner surface 311 of a recess 310 of a bracket adapter 300 is equal to the length of a second dimension of an inner surface 311 of a recess 310 of a bracket adapter 300.

Exemplary embodiments of the invention are described in more detail with reference to the accompanying drawings. The invention may, however, be embodied in different forms and should not be constructed as limited to the embodiments set forth herein. Rather, these embodiments are provided so that this disclosure will be thorough and complete, and will fully convey the scope of the invention to those skilled in the art. Throughout the disclosure, like reference numerals refer to like parts throughout the various figures and embodiments of the invention.

### DETAILED DESCRIPTION OF DRAWINGS

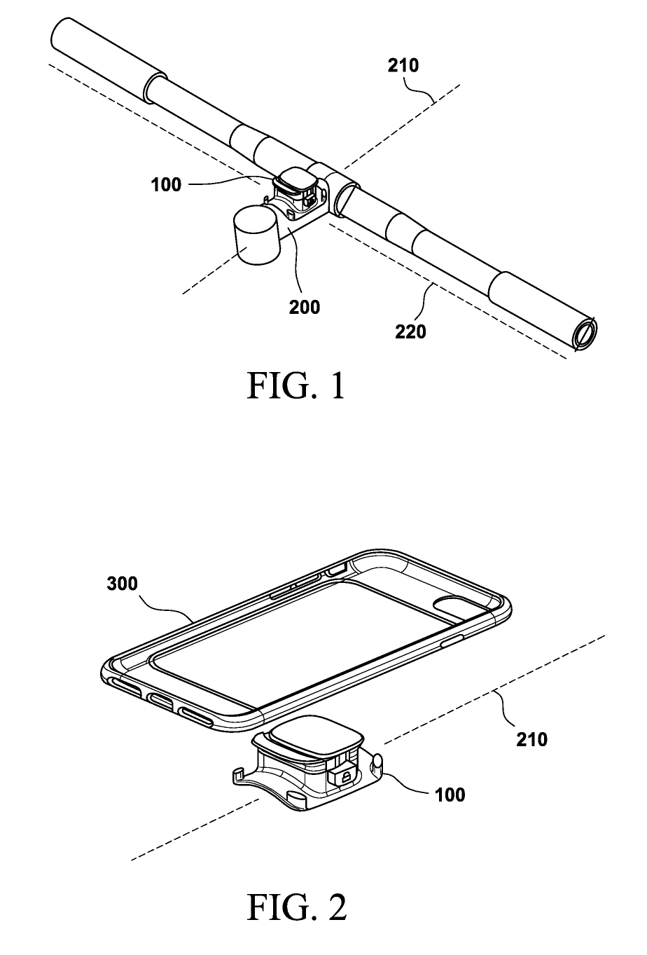

FIG. 1 shows a mounting system 100 according to an embodiment of the invention. The mounting system 100 rests on a supporting member 200, wherein the supporting member 200 in this embodiment is a part of a handlebar assembly for a bicycle, motorcycle, moped, or e-bike.

FIG. 2 shows a mounting system 100 and a bracket adapter 300 according to an embodiment of the invention. In the figure shown, the bracket adapter 300 is oriented to engage with the mounting system 100 parallel a longitudinal axis 210 of a supporting member 200 such that a mobile device attached to the bracket adapter 300 would be demountably fixed in a profile orientation, wherein the profile orientation is with respect to the longitudinal axis 210 of a support member 200. In the same embodiment, the bracket adapter 300 may also be demountably fixed in a landscape orientation with respect to the longitudinal axis 210 of a support member 200.

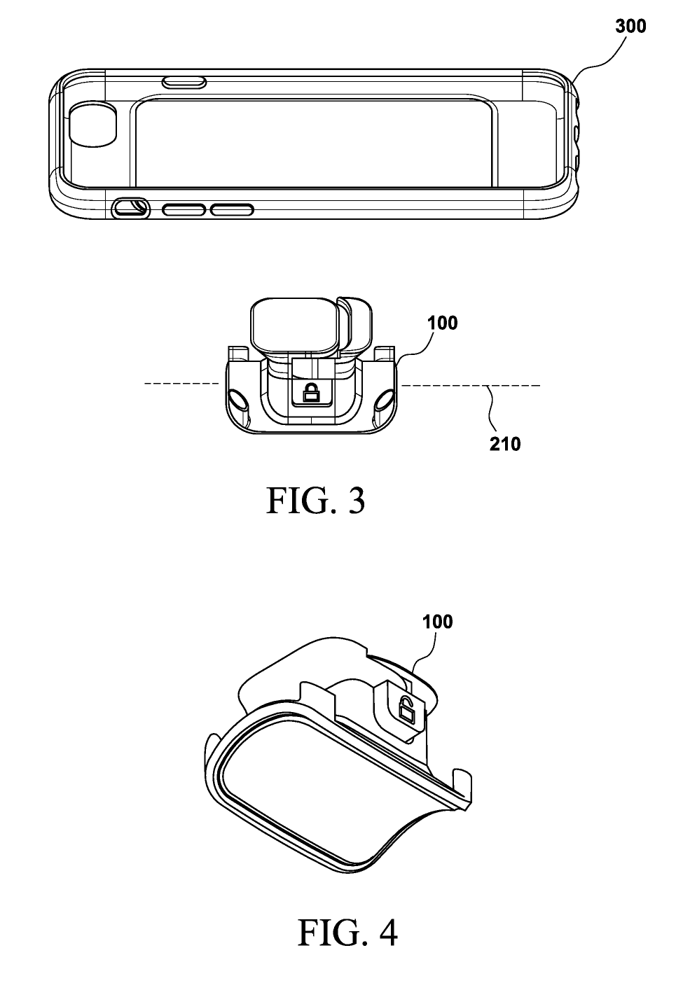

FIG. 3 shows a side view of a mounting system 100 and a bracket adapter 300 according to an embodiment of the invention.

FIG. 4 shows a bottom perspective view of a mounting system 100 according to an embodiment of the invention, wherein a locking mechanism 140 is in a locked position.

In another embodiment of the invention shown in the figure, the base 110 is configured to engage with a cylindrical rod as a support member 200.

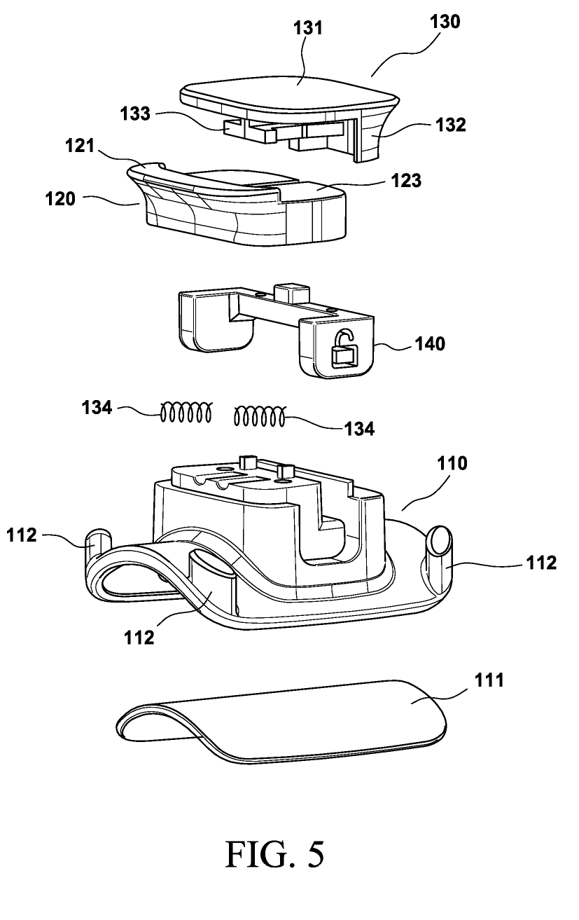

FIG. 5 shows an exploded view of a mounting system 100 according to an embodiment of the invention. The mounting system 100 comprises a first upper body 120 and a second upper body 130. The first upper body 120 comprises a rectangular top face 121, a first tapered lip 122, and a groove 123. The second upper body comprises a rectangular top face 131, a tapered lip 132, and a sliding mechanism 133. The sliding mechanism 133 of the second upper body 130 engages with the groove 123 of the first upper body 120. A locking mechanism 140, may slide in a direction orthogonal to the direction of movement of the sliding mechanism 133. When in a locked position, the locking mechanism 140 prevents movement of the sliding mechanism 133. When the locking mechanism 140 is in an unlocked position, the sliding mechanism is able to move freely. Springs 134 return the sliding mechanism 133 to an open state. A base 110 comprises a base bottom 111. The base 110 may also comprise a plurality of protrusions 112.

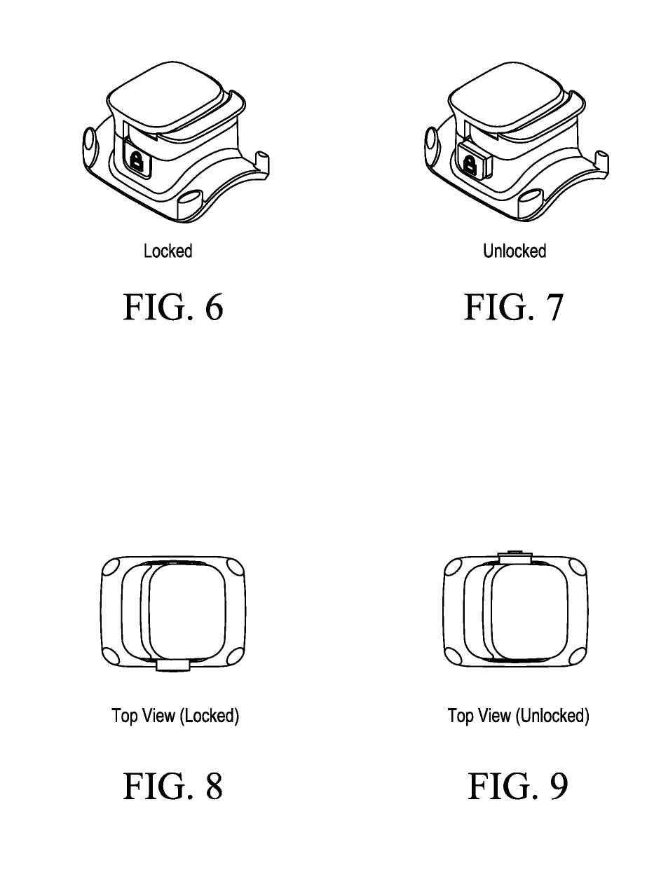

FIG. 6 shows a view of a mounting system 100 according to an embodiment of the invention, in a locked position.

FIG. 7 shows a perspective view of a mounting system 100 according to an embodiment of the invention, in an unlocked position.

FIG. 8 shows top view of a mounting system 100 according to an embodiment of the invention, in a locked position.

FIG. 9 shows a top view of a mounting system 100 according to an embodiment of the invention, in an unlocked position.

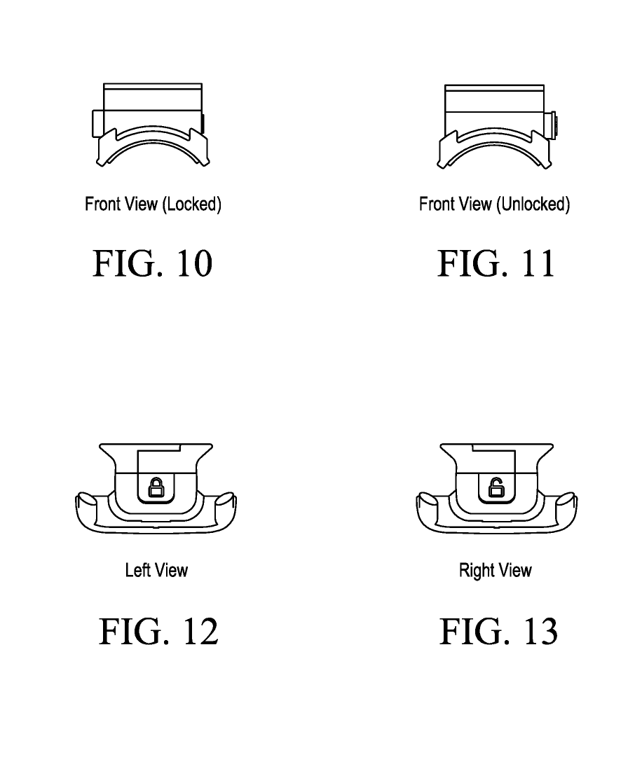

FIG. 10 shows a front view of a mounting system 100 according to an embodiment of the invention, in a locked position.

FIG. 11 shows a front view of a mounting system 100 according to an embodiment of the invention, in an unlocked position.

FIG. 12 shows a side view of a mounting system 100 according to an embodiment of the invention, in a closed position.

FIG. 13 shows an alternate side view of a mounting system 100 according to an embodiment of the invention, in a closed position.

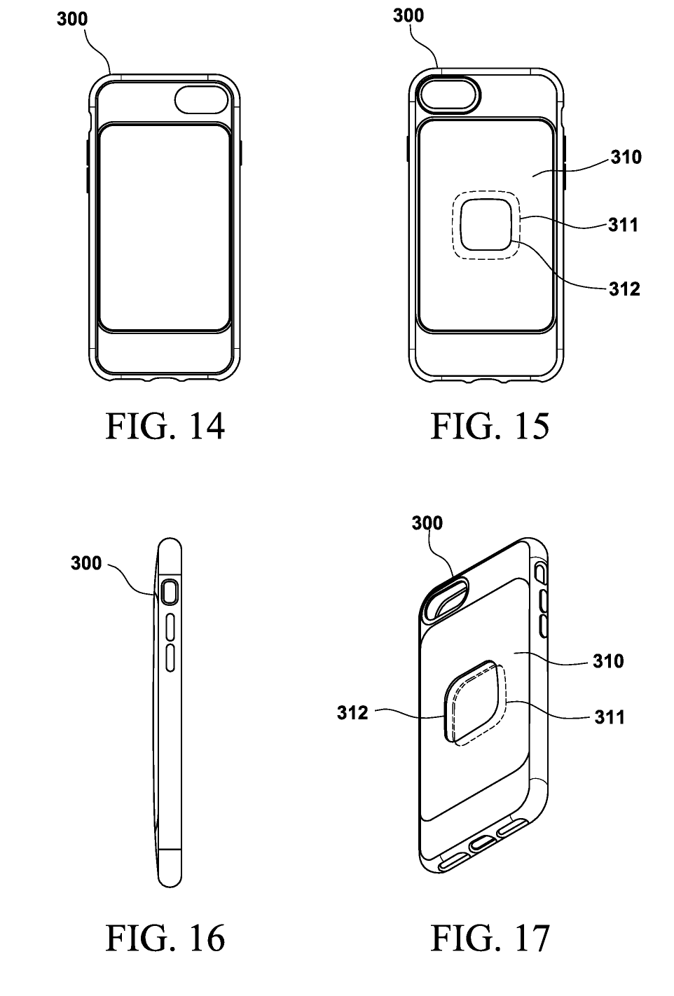

FIG. 14 shows a front view of a bracket adapter 300 according to an embodiment of the invention.

FIG. 15 shows a back view of a bracket adapter 300 according to an embodiment of the invention. The bracket adapter of the embodiment comprises a recess 310, which further comprises an inner surface 311 and an outer opening 312.

FIG. 16 shows a side view of a bracket adapter 300 according to an embodiment of the invention. The bracket adapter of the embodiment comprises a recess 310, which further comprises an inner surface 311 and an outer opening 312.

FIG. 17 shows a perspective view of a bracket adapter 300 according to an embodiment of the invention. The bracket adapter of the embodiment comprises a recess 310, which further comprises an inner surface 311 and an outer opening 312.

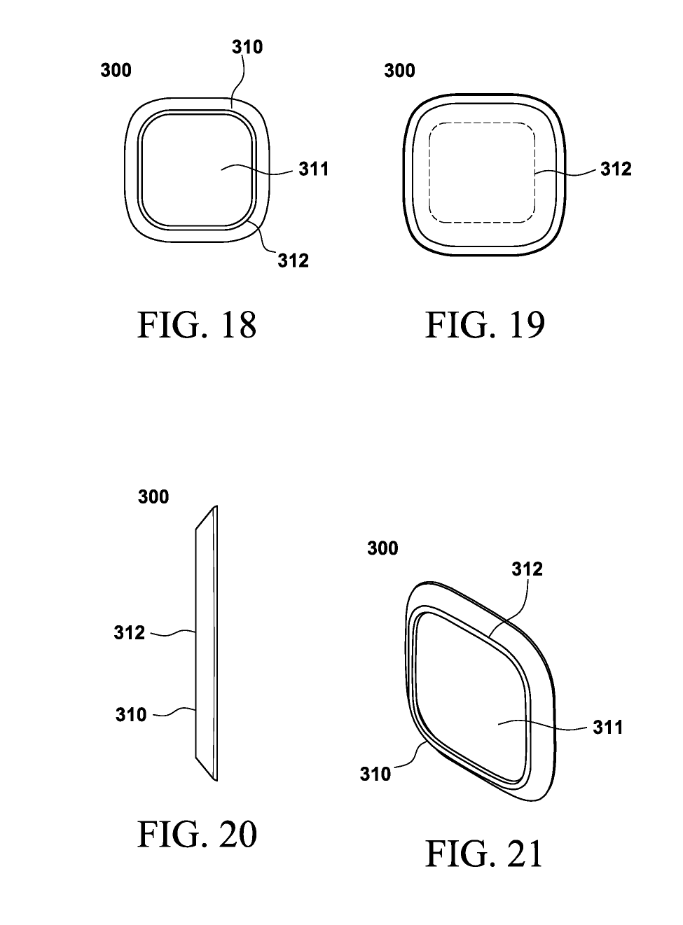

FIG. 18 shows a top view of a bracket adapter 300 according to another embodiment of the invention. The bracket adapter of the embodiment comprises a recess 310, which further comprises an inner surface 311 and an outer opening 312.

FIG. 19 shows a bottom view of a bracket adapter 300 according to an embodiment of the invention. The bracket adapter of the embodiment comprises a recess 310, which further comprises an outer opening 312.

FIG. 20 shows a side view of a bracket adapter 300 according to an embodiment of the invention. The bracket adapter of the embodiment comprises a recess 310, which further comprises an inner surface 311 and an outer opening 312.

FIG. 21 shows a perspective view of a bracket adapter 300 according to an embodiment of the invention. The bracket adapter of the embodiment comprises a recess 310, which further comprises an inner surface 311 and an outer opening 312.

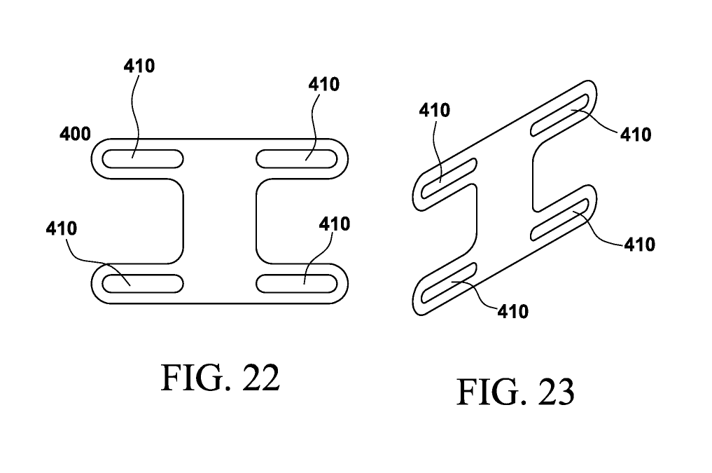

FIG. 22 shows a top view of a fastener 400 according to an embodiment of the invention, comprising a plurality of openings 410.

FIG. 23 shows a perspective view of a fastener 400 according to an embodiment of the invention, comprising a plurality of openings 410.

A summary of the reference numbers in the FIGs are as following:

100: mounting system;

200: support member;

300: bracket adapter;

400: fastener;

110: base;

111: base bottom;

112: protrusion;

120: first upper body;

121: rectangular top face;

122: first tapered lip;

123: groove;

130: second upper body;

131: rectangular top face;

132: tapered lip;

133: sliding mechanism;

134: spring;

140: locking mechanism;

210: longitudinal axis;

220: perpendicular axis;

310: recess;

311: inner surface;

312: outer opening; and

410: opening.

While the invention has been described with respect to the specific embodiments, it will be apparent to those skilled in the art that various changes and modifications may be made without departing from the spirit and scope of the invention as defined in the listed claims.

1. A mounting system for a mobile device comprising:
a base having a bottom configured to rest on a support member;
a first upper body having a substantially rectangular top face;
a second upper body having a substantially rectangular top face; and
a spring-loaded sliding mechanism configured to slide the second upper body with respect to the first upper body;
wherein the first upper body is fixedly attached to the base and the second upper body is moveably attached to the base.

2. The mounting system according to claim 1, wherein the substantially rectangular top face of the first upper body and the substantially rectangular top face of the second upper body form a square when in a combined state.

3. The mounting system according to claim 1, wherein the base includes a plurality of protrusions.

4. The mounting system according to claim 3, further comprising an elastic fastener adapted to engage with one of the plurality of protrusions.

5. The mounting system according to claim 4, wherein a first of the plurality of protrusions is located at a different corner of the base from a second of the plurality of protrusions.

6. The mounting system according to claim 5, wherein the first of the plurality of protrusions and the second of the plurality of protrusions protrudes in a direction perpendicular to the longitudinal axis of the support member.

7. The mounting system according to claim 1, further comprising a locking mechanism.

8. The mounting system according to claim 7, wherein the locking mechanism is adapted to slide along an axis perpendicular to the longitudinal axis of the support member.

9. The mounting system according to claim 1, wherein the support member is shaped to receive a cylindrical rod.

10. The mounting system according to claim 1, wherein the substantially rectangular top face of the first upper body has a surface area less than the surface area of the substantially rectangular top face of the second upper body.

11. The mounting system according to claim 1, wherein the first upper body further comprises a groove.

12. A mounting system for a bracket comprising:
a base having a bottom surface adapted to rest on a support member;
a first upper body having a substantially rectangular top face;
a second upper body having a substantially rectangular top face; and
a spring-loaded sliding mechanism adapted to slide the second upper body with respect to the first upper body;
wherein the first upper body is fixedly attached to the base and the second upper body is moveably attached to the base, and
a bracket adapter adapted to engage with the first upper body and the second upper body.

13. The mounting system for a bracket according to claim 12, wherein the bracket adapter comprises a recess defining an opening sized to allow entry into the recess of the first upper body and the second upper body when the substantially rectangular top face of the first upper body and the substantially rectangular top face of the second upper body are combined to form a substantial square.

14. The mounting system for a bracket according to claim 13, wherein the recess comprises an inner surface; and an outer opening.
